(19) United States
(12) Patent Application Publication
(10) Pub. No.: US 2012/0223281 A1
(43) Pub. Date: Sep. 6, 2012

(54) MULTI-PURPOSE JACK

(76) Inventor: Haoliang ZHOU, Hangzhou City (CN)

(21) Appl. No.: 13/243,283

(22) Filed: Sep. 23, 2011

(30) Foreign Application Priority Data
Mar. 1, 2011 (CN) 201120058938.0

(51) Int. Cl. B66F 3/24

(52) U.S. Cl. 254/93 R

(57) ABSTRACT

An automobile jack may include a base, a hydraulic cylinder, and a raising arm. The raising arm is driven by a hydraulic cylinder and the bottom of the raising arm is installed on the base, and the top of the raising arm is connected to a top plate. Two parallelly arranged removable frames placed on the upper side of the top plate. The top plate may also have supporting columns to raise the height of the removable frames, and pre-drilled holes for the storage of the supporting columns. By using two supporting columns, the removable frames may be dissembled and sit on the top plate, and may be kept on the top plate when not in use. This reduces the storage space. The removable frames may be also easily installed when it is required to raise the height. This increases the working efficiency and is easy to use.

### BACKGROUND OF THE INVENTION

This invention relates to a jack for automobile maintenance and repair, particularly to a multi-purpose automobile jack.

An automobile jack is generally used to lift a car so that the car may be checked and parts may be replaced. If the height of the lift is not enough, raised supports are sometimes used on the top plate of the jack to increase the height of lift. An example is shown in FIG. 1. Two raised supports 3-1 are arranged parallelly on top plate 2-1 of the jack. The raised supports 3-1 have two columns 3-12 underneath that are inserted into installation holes of the top plate. The disadvantage of this type of jack is that the raised supports have to be removed from the top plate of the jack and stored separately after use. This increases the storage space and inconvenience of use.

### BRIEF SUMMARY OF THE INVENTION

The technical issues to be solved by this invention are to overcome aforementioned disadvantages. This invention provides an improved jack that is simple and easy to use.

In some embodiments, the jack includes a base, a hydraulic cylinder, a raising arm, and a top plate. The raising arm is driven by the hydraulic cylinder and the bottom of the raising arm is installed on the base, and the top of the raising arm is connected to a top plate. In addition, there are two parallelly arranged removable frames placed on the upper side of the top plate. The top plate may also have supporting columns to raise the height of the removable frames. The top plate may also have pre-drilled holes for the storage of the supporting columns.

The top plate may have two sets of installation holes so that the removable frames can be slidably installed in the installation holes, and the diameter of the installation holes matches the diameter of the installation columns that are located at the bottom of the removable frames.

A first end of the supporting column has an outer diameter that matches the diameter of the installation holes. A second end of the supporting column has a supporting hole that has an inner diameter matches the diameter of the installation column.

The general operation principle is that in normal situation the supporting columns are stored in the storage holes and the removable frames are inserted in the installation holes of the top plate (as shown in FIG. 3). The removable frames sit on top of the supporting column to prevent the stored supporting columns from jumping up in the storage holes. When in use, the removable frames are firstly removed from the installation holes and the supporting columns are removed from the storage holes; the first ends of the supporting columns are then inserted into the installation holes; and the installation columns of the removable frames are then inserted into the second ends of the supporting columns, and therefore the lifting height of the jack may be increased (as shown in FIG. 4).

The advantage of this invention is that by using two supporting columns, the removable frames may be dissembled and sit on the top plate. The removable frames may be kept on the top plate and do not have to be removed from the top plate when not in use. This reduces the storage space. The removable frames may be also easily installed when it is required to raise the height. This increases the working efficiency and is easy to use.

### BRIEF DESCRIPTION OF THE DRAWINGS

FIG. 1 shows an example of a jack of prior art.

FIG. 2 shows an embodiment of a jack according to this invention without the removable frames.

FIG. 3 shows an embodiment of a jack according to this invention without the supporting columns.

FIG. 4 shows an embodiment of a jack according to this invention with the supporting columns and the removable frames installed.

FIG. 5 shows an embodiment of the removable frames.

FIG. 6 shows an embodiment of the supporting columns.

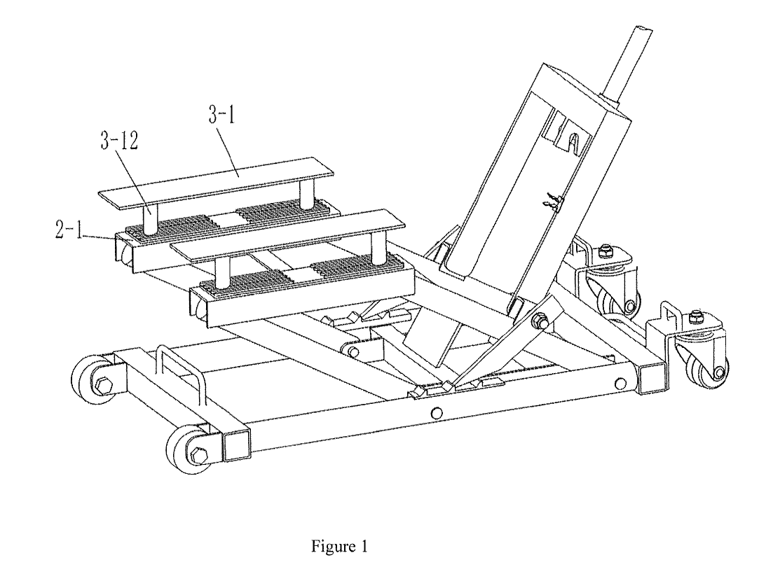

### DETAILED DESCRIPTION OF THE INVENTION

A detailed description of the invention is hereafter described with specific reference being made to the drawings.

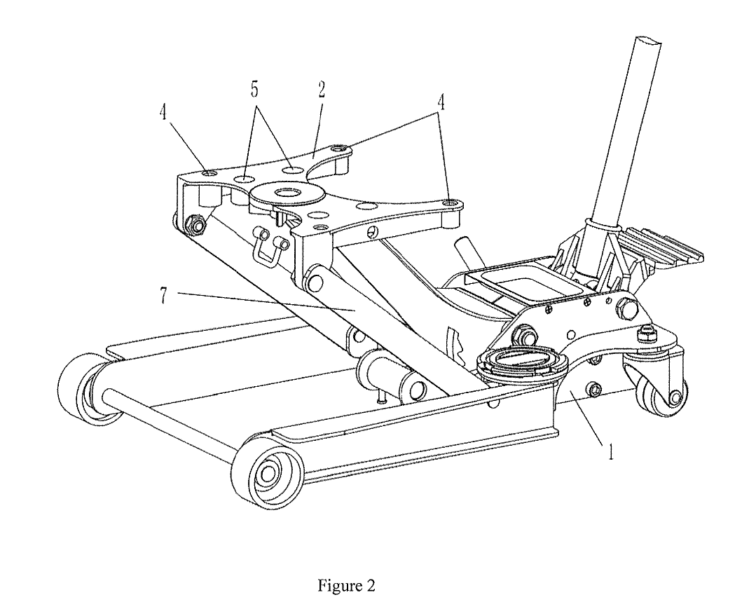

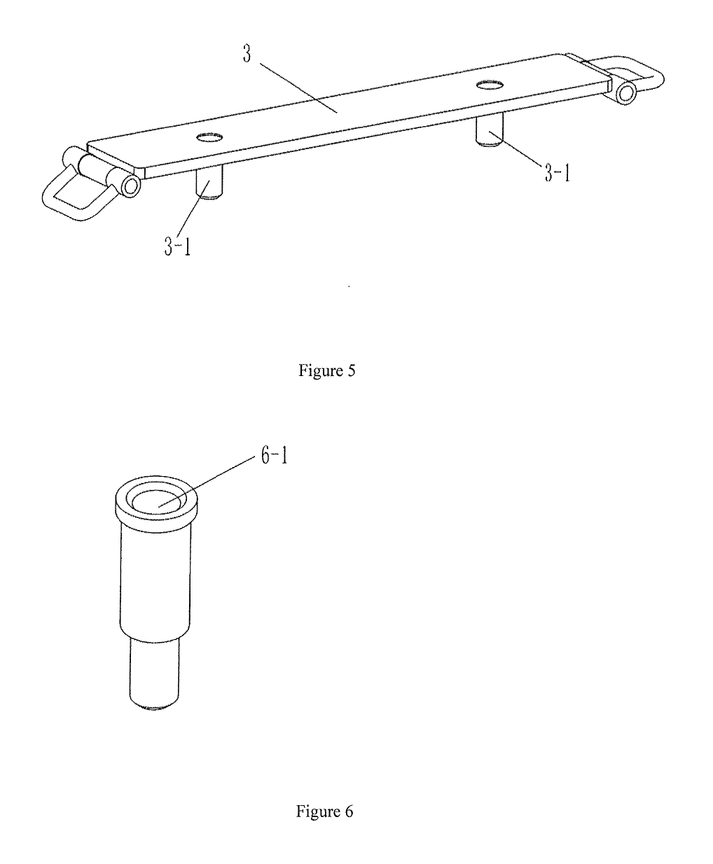

As shown in FIG. 2, the multipurpose jack may include a base 1 (main component of the jack), a raising arm 7, a hydraulic cylinder to drive the raising arm 7 (to simplify the figure, the hydraulic cylinder is omitted in the figure), a top plate 2 installed on the raising arm 7. The bottom of the raising arm is installed on the base. The jack may also include two parallelly arranged removable frames 3. (As shown in FIG. 5, the removable frames 3 may have two installation columns 3-1 projecting vertically from the bottom of the removable frames 3) The structures of these components are similar to a regular jack, and the principles of the operation are known and do not require detailed description herein.

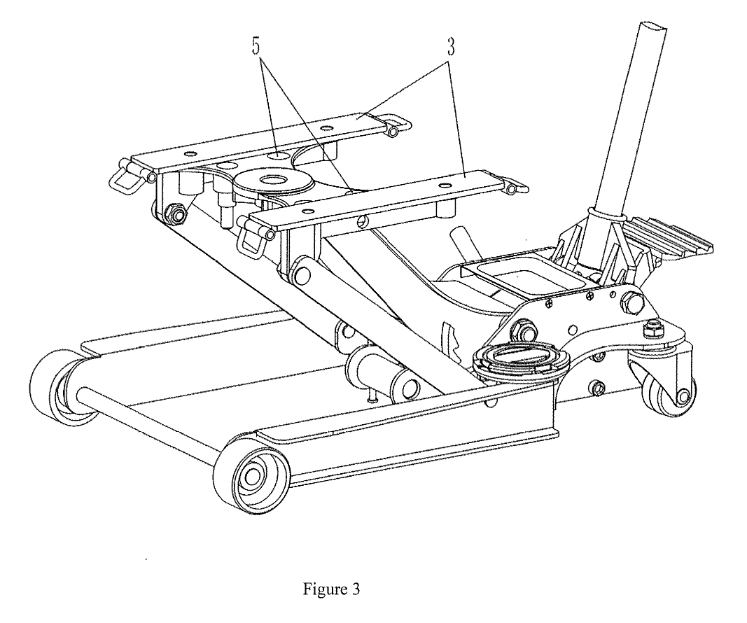

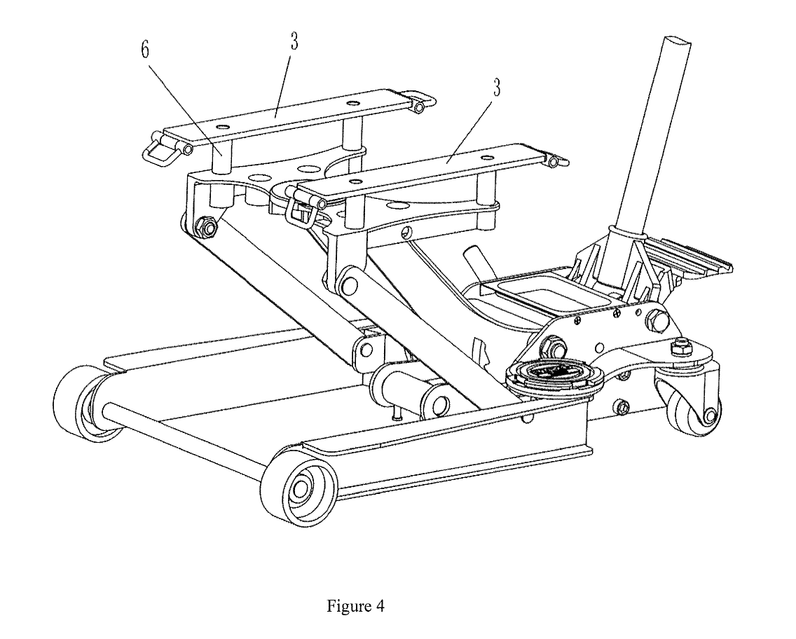

The improvement of this invention includes that the top plate 2 may be equipped with supporting columns to raise the height of the removable frames, and the top plate may also have pre-drilled storage holes 5 for the storage of the supporting columns 6. As shown in FIGS. 3 and 4, when there is no need to raise the height of the jack, the removable frames may be stored on the top plate 2, which is similar to a regular jack. As shown in FIG. 2, the top plate 2 may have installation holes 4 for installing removable frames. The inner diameter of the installation holes 4 matches the outer diameter of the installation columns 3-1. The structure of the supporting columns is shown in FIG. 6. A first end of the supporting columns 6 has a diameter that matches the diameter of the installation holes and the second end of the supporting column has a supporting hole 6-1, which has a diameter that matches the diameter of the installation columns 3-1. When it is necessary to raise the lifting height of the jack, the supporting columns may be removed from the storage holes, and the first end of the supporting column may be inserted into the installation holes and the installation columns of the removable frames may be inserted into the supporting holes 6-1 so as to raise the height of the jack.

The height of the supporting columns 3-1 may vary. The depth of the storage holes 5 may match the height of the supporting columns 3-1. As shown in FIG. 2, in some embodiments, the storage holes may be positioned close to the removable frames when not in use. The storage holes may also be placed in other places on the top plate or the jack.

1. A multi-purpose jack comprising
a base;
a hydraulic cylinder;
a raising arm driven by the hydraulic cylinder installed on the base;
a top plate installed on the raising arm;
a removable frame having an installation hole; and
a supporting column having a first end and a second end,
wherein the top plate has a storage hole configured to store the supporting column.

2. The multi-purpose jack of claim 1, wherein the top plate has an installation hole and the diameter of the installation hole matches the outer diameter of the installation column.

3. The multi-purpose jack of claim 1, wherein the outer diameter of the supporting column matches the diameter of the installation hole, the second end of the supporting column has a supporting hole configured to allow the installation column to slide into the supporting hole.

4. The multi-purpose jack of claim 2, wherein the outer diameter of the supporting column matches the diameter of the installation hole, the second end of the supporting column has a supporting hole configured to allow the installation column to slide into the supporting hole.
